(19) United States
(12) Patent Application Publication
(10) Pub. No.: US 2009/0119608 A1
(43) Pub. Date: May 7, 2009

(54) FACE AND SUBJECT TAGGING WITH RELATIONSHIP INDEXING IN FILES TO ENHANCE ORGANIZATION AND USABILITY

(76) Inventor: Scott David Huskey, Hillsboro, OR (US)

Correspondence Address: MARGER JOHNSON & MCCOLLOM, P.C., 210 SW MORRISON STREET, SUITE 400, PORTLAND, OR, 97204, US

(21) Appl. No.: 12/253,091

(22) Filed: Oct. 16, 2008

Related U.S. Application Data
(60) Provisional application No. 61/001,546, filed on Nov. 5, 2007.

(51) Int. Cl. G06F 17/30; G06F 3/048

(52) U.S. Cl. 715/764; 707/104.1; 707/1; 707/E17.044; 707/E17.001

(57) ABSTRACT

A machine includes a file database, a tag database, and a relationship database. The file database stores files. The tag database stores tags that can be associated with the files in the file database. The relationship database stores relationships between the tags stored in the tag database, including family relationships (both direct and indirect), positional relationships, and peer relationships. The machine can also include a portrait database to store portraits of tags in the tag database.

### RELATED APPLICATION DATA

This application claims the benefit of U.S. Provisional Patent Application No. 61/001,546, filed Nov. 5, 2007, and is herein incorporated by reference for all purposes.

### FIELD OF THE INVENTION

This invention pertains to managing tagged files, and more particularly to managing relationships between tags in tagged files.

### BACKGROUND OF THE INVENTION

Back when photography was an analog process, involving film and developed photographs using special paper, people would sometimes make notes about the photographs. For example, people would sometimes notate who the people were in a particular photograph. By annotating photographs in this matter, people would take information that otherwise might be simply oral history, and easily forgotten, and turn it into a written record. As a result of these annotations, some people today know exactly what their ancestors looked like several generations back, even though they might never have met those ancestors personally.

But film is an expensive medium, as is photographic paper. Even worse, the manual labor required to develop film and to print photographs is expensive. Rather than having a store develop every piece of film into a picture, people would take the film to the store, have the store develop the film, and print a contact sheet—roughly equivalent to today's concept of thumbnail images of pictures. The individual could then look over the contact sheet, identify the desired pictures, and then request the store to print just those pictures. And while the development of automated machines to develop film and print images as removed the manual labor component from the cost of producing photographs, developing film and producing photographs still costs some money.

The development of digital photography—pictures taken with a digital camera and stored on a computer—has caused a proliferation of saved images. Whereas before it was expensive to print and store individual pictures, now an individual can take a huge number of pictures: the number is bounded only by the size of the memory in the camera on which the pictures are stored. In addition, the user can see what the photos look like almost instantaneously. As a result of these developments, users are producing and storing photographs at a faster rate than ever before.

The concept of annotating photographs has translated to the digital age as well. Called “tagging”, a user can annotate a digital photograph in any manner desired: for example, by naming the subjects of the photograph. As before, the tags provide a way for users who are unfamiliar with the subjects of the photograph to know who or what those subjects are.

But there are limits to the capabilities of tagging. For example, just because a digital photograph is tagged with the name “John Public” does not inform a viewer of the digital photograph much more than a name. If there are multiple “John Public”s in the world, the viewer of the digital photograph does not know which “John Public” is referred to, or anything else about that “John Public”.

A need remains for a way to address these and other problems associated with the prior art.

### SUMMARY OF THE INVENTION

In an embodiment of the invention, a machine includes a file database to store files, a tag database to store tags associated with the files in the file database, and the relationship database to store relationships between tags in the tag database. Given a particular tag in the tag database, the relationships between tags in the tag database can be used, for example, to identify other subjects of photographs in the files in the file database, and to show their relationship to the particular tag.

The foregoing and other features, objects, and advantages of the invention will become more readily apparent from the following detailed description, which proceeds with reference to the accompanying drawings.

### BRIEF DESCRIPTION OF THE DRAWINGS

FIGS. 1A-1B show a machine equipped to manage relationships between tags, according to an embodiment of the invention.

FIG. 2 shows an image file stored in the file database of FIG. 1A with associated tags.

FIG. 3 shows the relationship database of FIG. 1A including some additional relationships.

FIGS. 4A-4B show the relationship deducer of FIG. 1B deducing additional relationships between tags of the tag database of FIG. 1A.

FIG. 5 shows various types of files that can be stored in the file database of FIG. 1A.

FIG. 6 shows the relationship database of FIG. 1A storing a relationship between files in different file databases.

FIG. 7A shows the set of direct family relationships in the relationship database of FIG. 1A centered on a particular tag in the tag database of FIG. 1A.

FIG. 7B shows the result of a user selecting a different tag as a center point in the display of FIG. 7A.

FIG. 8 shows a set of relationships, including indirect relationships, in the relationship database of FIG. 1A centered on a particular tag in the tag database of FIG. 1A.

FIG. 9A shows a set of files in the file database of FIG. 1A associated with a particular tag in the tag database of FIG. 1A.

FIG. 9B shows a result of the user selecting a particular file in the display of FIG. 9A.

FIGS. 10A-10B show a flowchart of a procedure to establish a direct family relationship in the relationship database of FIG. 1A between tags in the tag database of FIG. 1A.

FIG. 11 shows a flowchart of a procedure to associate a tag in the tag database of FIG. 1A with a subset of a file in the file database of FIG. 1A.

FIGS. 12-13 show a flowchart of a procedure to present to a user information relating to a tag in the tag database of FIG. 1A.

FIG. 14 shows a flowchart of a procedure to present to a user information relating to a file in the file database of FIG. 1A.

### DETAILED DESCRIPTION OF THE PREFERRED EMBODIMENT

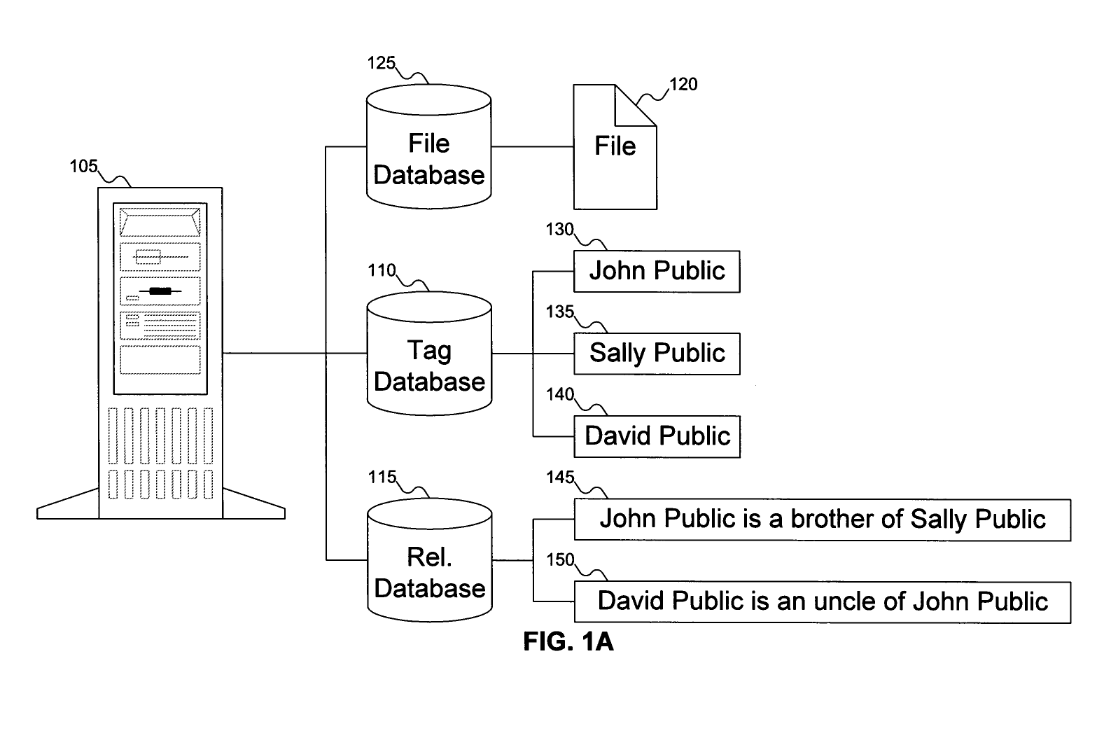

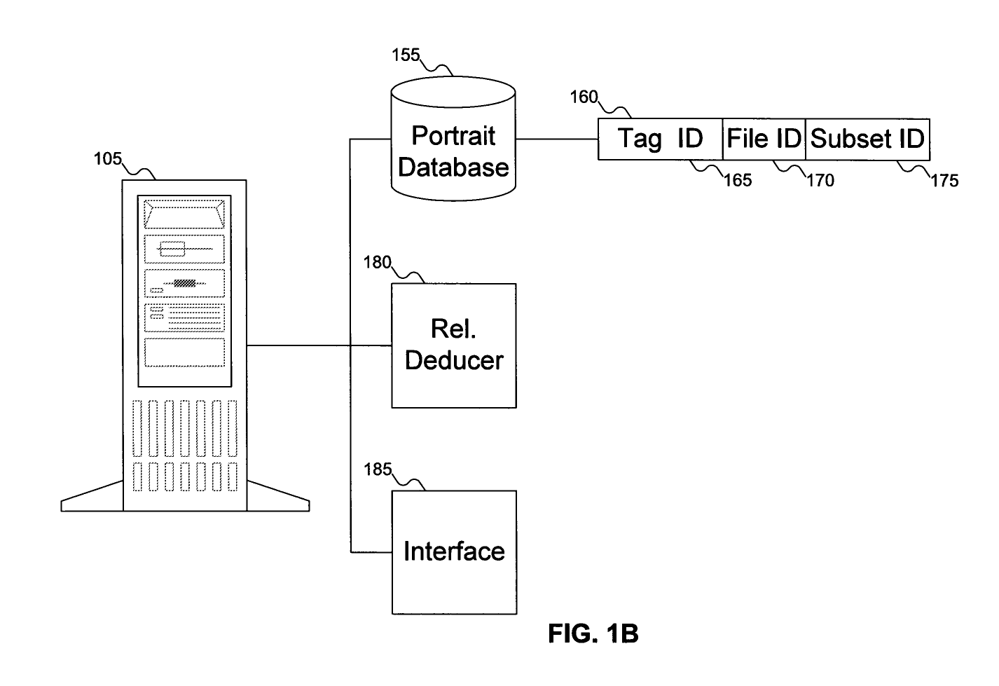

FIGS. 1A-1B show a machine equipped to manage relationships between tags, according to an embodiment of the invention. FIG. 1A shows machine 105, which can be, for example, a server or a user's personal computer. Not shown in FIG. 1A are additional components that may be included with machine 105, such as monitor 110, keyboard 115, and mouse 120, and other input/output devices, such as a printer. In addition, FIG. 1A does not show some of the conventional internal components of machine 105: for example, a central processing unit, memory, storage, etc. Although not shown in FIG. 1A, a person skilled in the art will recognize that machine 105 can interact with other computer systems either directly or over a network (not shown in FIG. 1A) of any type. Finally, although FIG. 1A shows machine 105 as a conventional computer, a person skilled in the art will recognize that machine 105 can be any type of computing device capable of providing the services attributed herein to machine 105, including, for example, a laptop computer, a personal digital assistant (PDA), or a cellular telephone.

Machine 105 includes file database 125, tag database 110, and relationship database 115. File database 125 stores files, such as file 120, that can have associated tags, such as tags 130, 135, and 140 stored in tag database 110. (A person skilled in the art will also recognize that file database 125 can store files with no associated tags, either because no tags are yet defined in tag database 110 that the user intends to associate with the file, or because the file is not meant to have any associated tags.) Tags can be assigned to files in any desired manner: for example, by clicking on the file and selecting to add a new tag to the file, or by dragging an existing tag onto a file, among other possibilities. When computer recognition of faces or other data reaches an appropriate level, it might be possible for machine 105 to automatically add tags to files based on their associations with other files. For example, if John Public tag 130 is known to be associated with a particular face, machine 105 could automatically tag any other files in file database 125 that include that face with John Public tag 130. A person skilled in the art will recognize that such automatic tagging could be extended in other directions: for example, based on voice recognition of an audio file.

Relationship database 115 stores relationships, such as relationships 145 and 150, between tags in tag database 110. For example, relationship 145 indicates that “John Public” (identified by tag 130) is a brother to “Sally Public” (identified by tag 135), and relationship 150 indicates that “David Public” (identified by tag 140) is an uncle to “John Public” (identified by tag 130). (To simplify the rest of this document, subjects will be referred to by their tag. Thus, for example, instead of saying that “John Public” is identified by tag 130, the rest of this document will refer to “John Public” tag 130. A person skilled in the art will understand when a reference is intended to refer to the tag or the subject identified by that tag. For example, relationship 145 can be described as indicating that “John Public” tag 130 is a brother to “Sally Public” tag 135: even though it is understood that one tag is not a “brother” to another tag, the subjects referred to in these tags can have such a relationship.)

A person skilled in the art will recognize that relationships 145 and 150 and merely representative of the underlying relationships, and that relationships 145 and 150 can be stored in relationship database 115 in other ways. For example, relationships 145 and 150 can be represented as links to the tags in question, along with a description of the relationship between the tags.

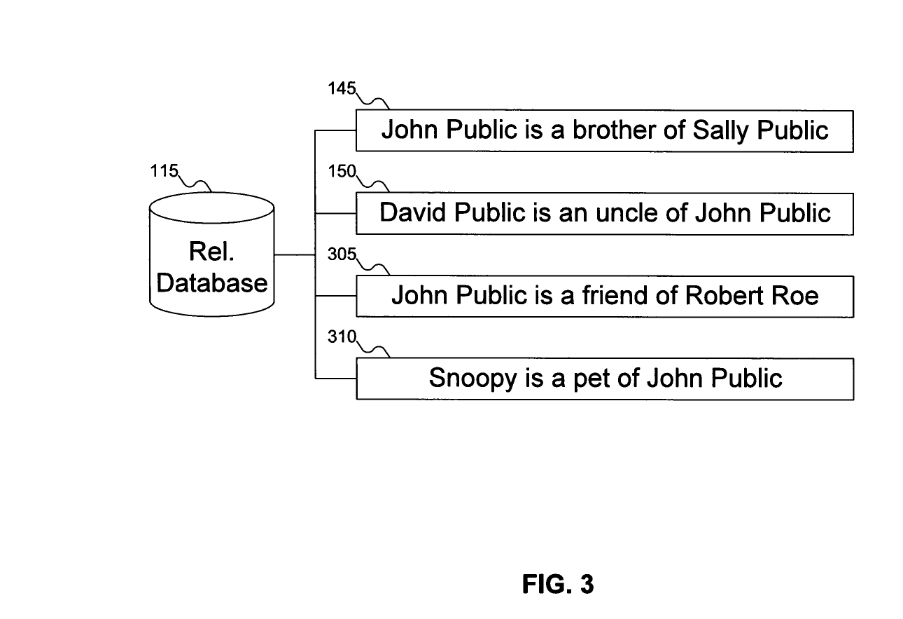

A person skilled in the art will also recognize that relationships are not symmetric: that is, to say that tag A has relationship R to tag B does not mean that tag B has relationship R to tag A. For example, in relationship 145, just because John Public tag 130 is a brother to Sally Public tag 135 does not mean that Sally Public tag 135 is a brother to John Public tag 130. There might be a mirror image relationship between the tags, but that mirror image relationship is not necessarily the same as the original relationship. Relationships are discussed more with reference to FIG. 3 below.

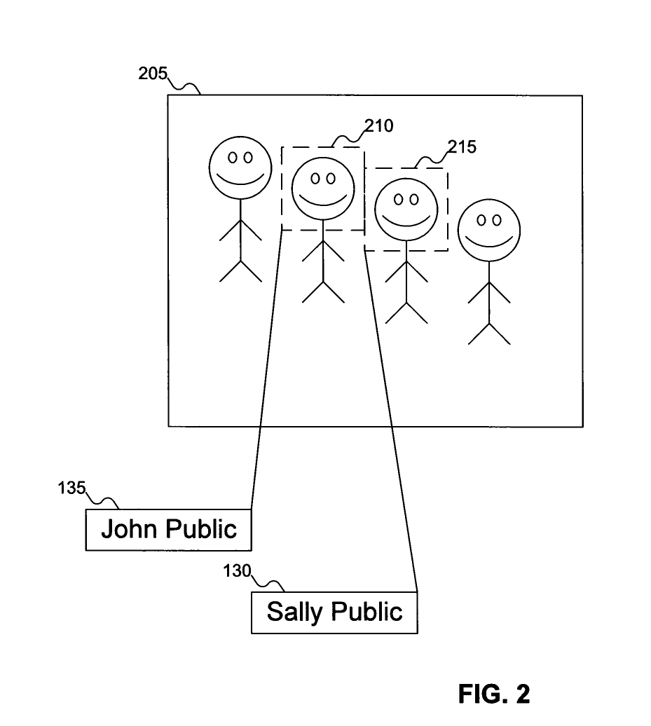

In FIG. 1B, machine 105 is further shown as including portrait database 155. Portrait database 155 can store information about portraits, such as portrait 160; a portrait can represent a subject of a tag. Portraits can then be used to represent tags to the user on a display. While the term “portrait” suggests that portrait 160 is a visual representation of a person, a person skilled in the art will recognize that a “portrait” can represent any desired object, animate or inanimate, and can take a form other than visual (for example, an audio clip can be a “portrait”). Because portraits can be defined by the user as a subset of a particular file in the file database, portrait database 155 can also be called a subset database. A portrait, or subset, can be defined as shown in portrait 160, identifying a tag (tag identifier 165) for which the portrait is to be used, a file (file identifier 170) containing the target subset, and the subset (subset identifier 175) within the identified file that defines the boundaries of the portrait within the file. Tag identifier 165 and file identifier 170 can be links to a tag in the tag database and a file in the file database, respectively; subset identifier 175 can identify the subset of the file in any manner desired. For example, if the desired subset of the file is a rectangular portion, subset identifier 175 can define two diagonally-opposite corners of the rectangle. Or, if the desired subset of the file is oval in shape, subset identifier 175 can define the parameters and location of the oval portion. A person skilled in the art will recognize how other subsets can be identified in portrait 160. In addition, mirroring how portrait 160 can identify the tag to which the portrait is associated (via tag identifier 165), the tag can identify the portrait associated with the tag (for example, by a link from the tag to the portrait). Subsets are discussed further with reference to FIG. 2 below.

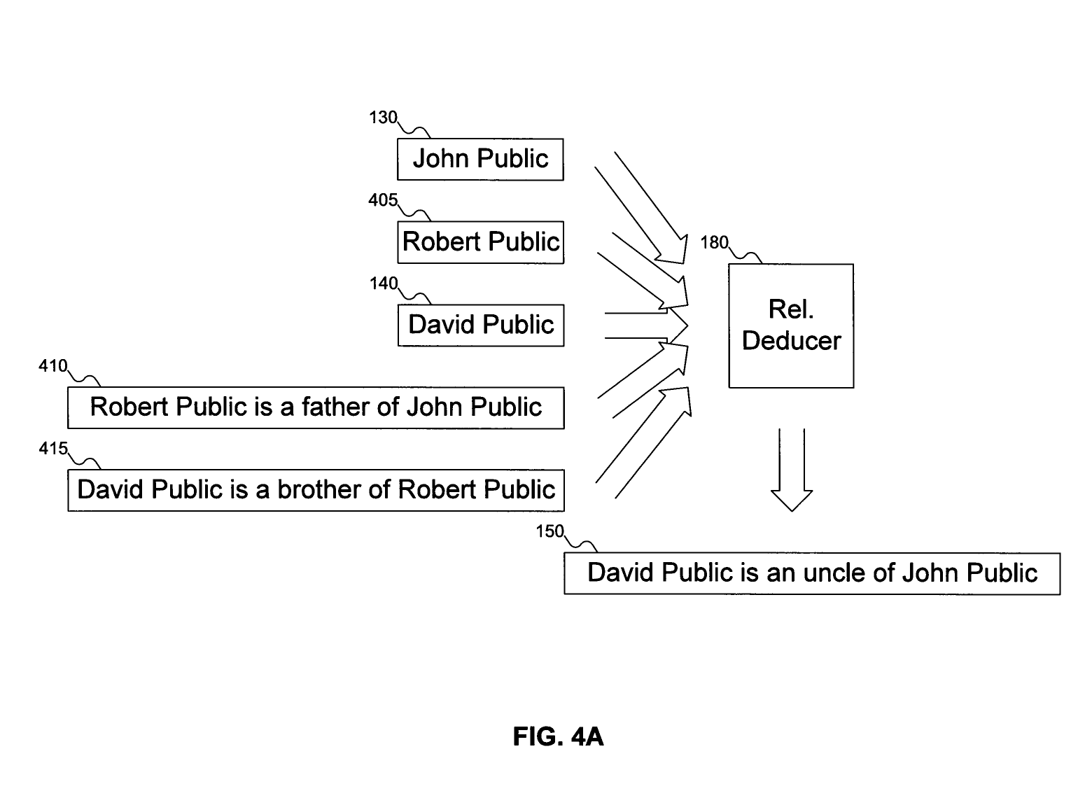

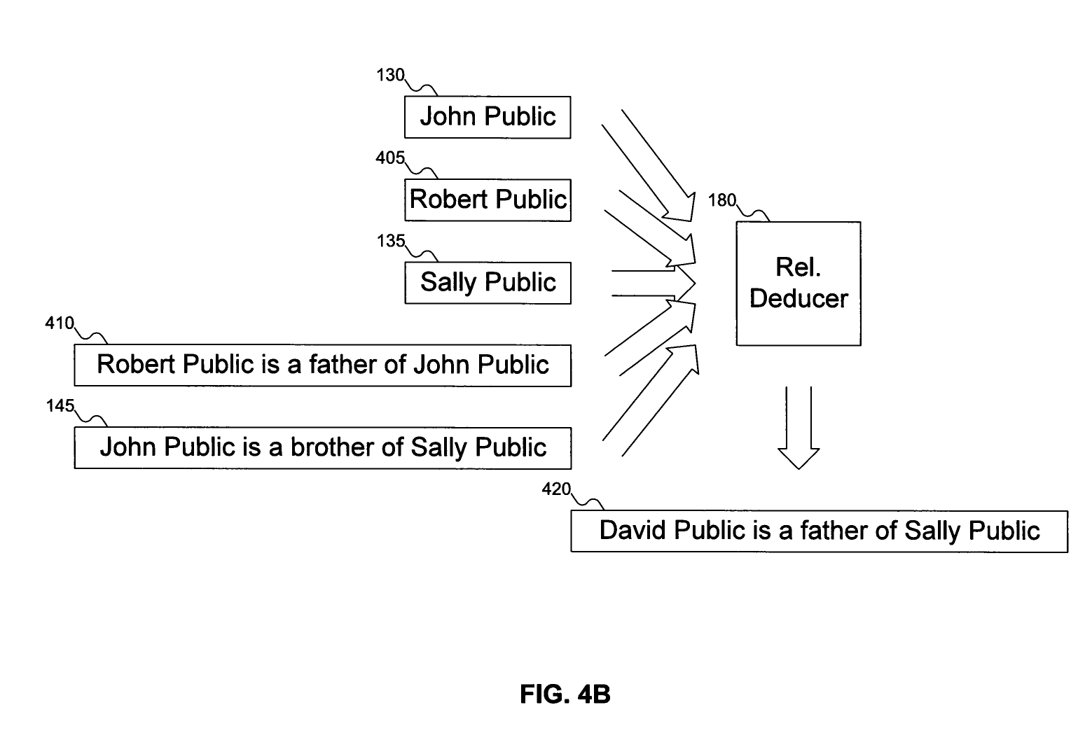

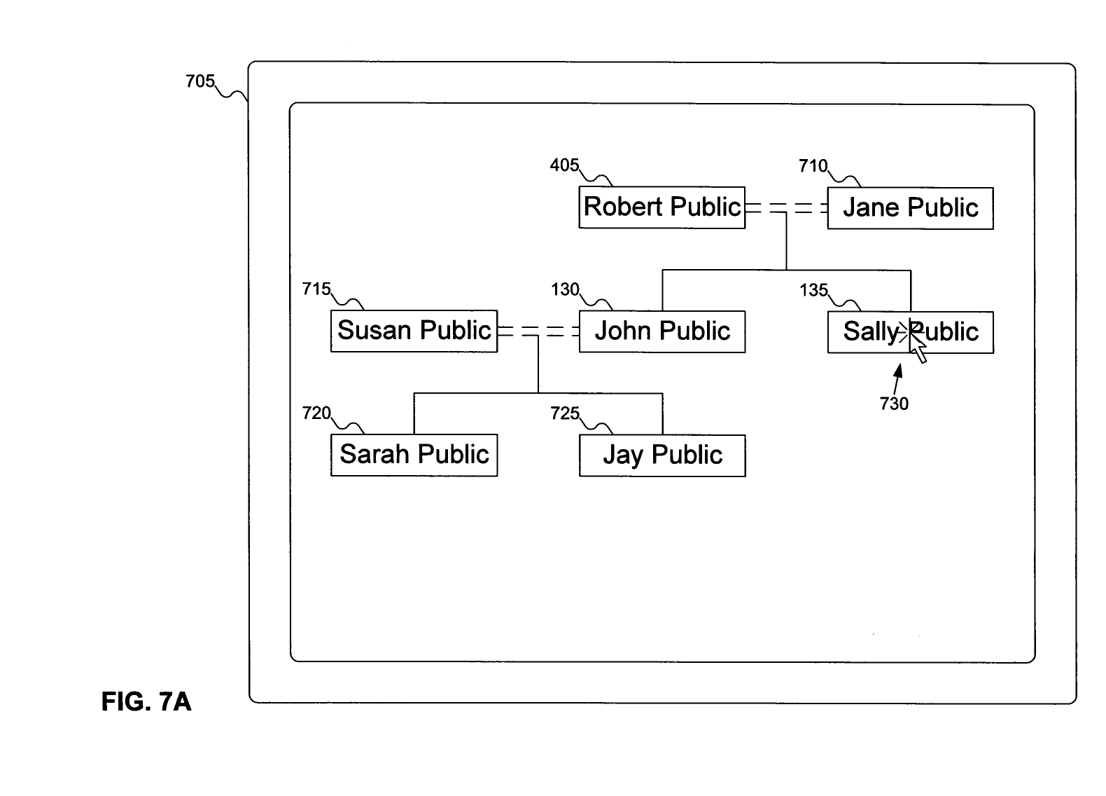

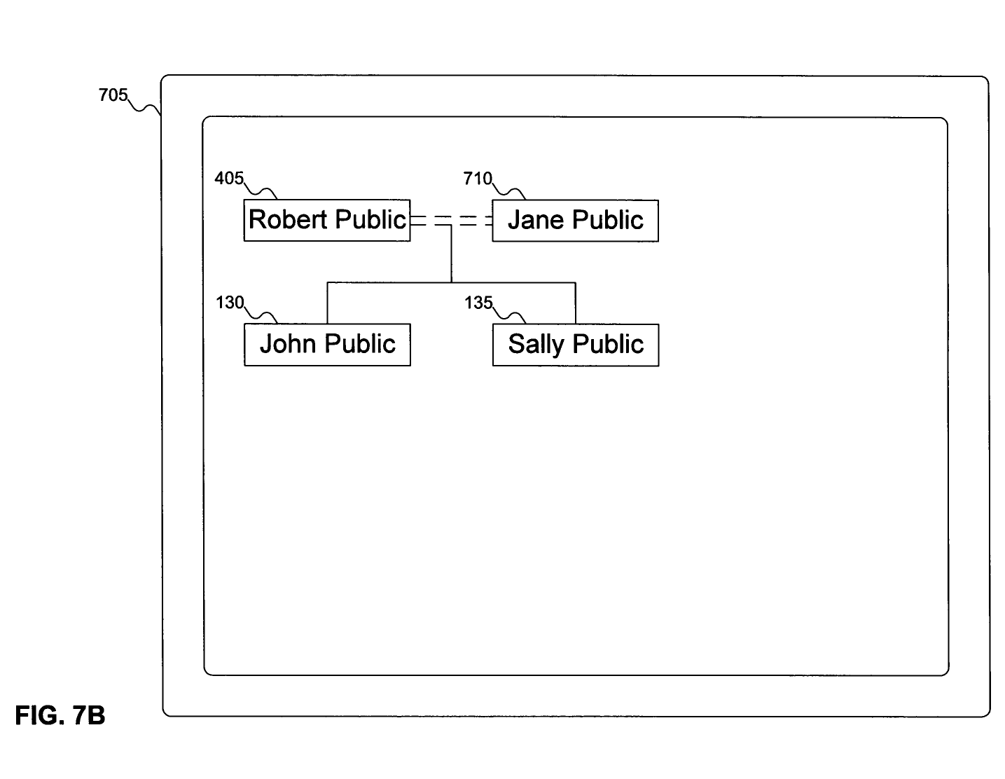

Machine 105 can also include relationship deducer 180 and interface 185. Relationship deducer 180 enables machine 105 to deduce relationships between tags in tag database 110, even where those deduce relationships are not explicitly presented by the user. Interface 185 enables machine 105 to present serious information to the user and to receive input from the user. Relationship deducer 180 is discussed further below with reference to FIGS. 4A-4B. interface 185 is discussed further below with reference to FIGS. 7A-9B.

FIG. 2 shows an image file stored in the file database of FIG. 1A with associated tags. In FIG. 2, image file 205 is shown as including four people. One of these people is identified as “John Public”, as shown by associated “John Public” tag 130. Another of these people is identified as “Sally Public”, as shown by associated “Sally Public” tag 135.

Although tags 130 and 135 can be associated with image file 205 as a whole, tags 130 and 135 can also be associated with more specific subsets of image file 205. Thus, for example, “John Public” tag 130 can be associated with subset 210 of image file 205. Similarly, “Sally Public” tag 135 can be associated with subset 215 of image file 205. In this manner, tags can be associated more particularly with the subjects of the files to which they refer, rather than to the files in general. Among the other capabilities enabled by associating tags with subset of files, interface 185 of FIG. 1B can use the subset of a file associated with the tag to identify the tag to the user, as discussed further below with reference to FIGS. 7A-9B.

While FIG. 2 shows subsets 210 and 215 as being square-shaped, a person skilled in the art will recognize that subsets 210 and 215 can be shaped in any manner desired by the user. Thus, subsets 210 and 215 could be shaped as circles, ovals, triangles, pentagons, hexagons, or any other desired shape, including arbitrarily-shaped polygons or free-form shapes drawn by the user.

While FIG. 2 shows tags 130 and 135 being associated with subsets 210 and 215 of image file 205, a person skilled in the art will recognize how tags can also be associated with subsets of files other than image files. For example, if the file in question is an audio file or a video file, the user can specify a portion of the file (that is, a time bounded interval of the file) and associate the tag with that subset of the file.

At this point, it is important to understand the different types of relationships that can exist between tags. Relationships can be classified in different ways. Some relationships are direct; others are indirect. Direct relationships are relationships that can be fully understood without needing to reference a third tag subject. For example, relationship 145 of FIG. 1A says that John Public is the brother of Sally Public. Given this information, the complete relationship between John Public and Sally Public is fully understood, and so relationship 145 is a direct relationship. (While it is useful to know who the parents of John Public and Sally Public are, knowing the identities of their parents does not give you a better understanding of the relationship between John Public and Sally Public. Specifically, Robert Public is the father of both John Public and Sally Public does not aid in understanding the relationship between John Public and Sally Public.)

In contrast to direct relationships, in direct relationships are relationships where there is some gap between the tag subjects. For example, relationship 150 of FIG. 1A says that David Public is the uncle of John Public. But unless the reader knows whether David Public is the brother of John Public's father or mother, the reader does not fully know the relationship between David Public and John Public, and so relationship 150 is an indirect relationship.

Given this understanding, it should be clear eight different direct family relationships. These are: A is a father of B, A is a mother of B, A is a brother of B, A is a sister of B, A is a husband of B, A is a wife of B, A is a son of B, and A is a daughter of B. all other family relationships are indirect.

In addition, relationships can be based on tag subjects being part of a well-defined hierarchy, or not. For example, a family tree defines a hierarchical relationship. Thus, one can say that relationship 145 is a direct family relationship, and relationship 150 is an indirect family relationship. In contrast, a relationship between, say, friends is a peer relationship: there is no hierarchy necessarily including both of the tag subjects. Other examples of peer relationships include teacher/student relationships, coach/player relationships, business partner relationships, and other user-defined peer relationships. Finally, there can be positional relationships, which can represent, for example, one tag subject owning another tag subject. Other objects that can be represented by a positional relationship include a favorite toy, a pet, first car, a science project, a creation, a sub-component, a container, a birthplace, a view, and other user-defined positional relationships. By definition, peer relationships and positional relationships cannot be direct.

FIG. 3 shows the relationship database of FIG. 1A including some additional relationships. As discussed above, relationships 145 and 150 show two types of relationships: a direct family relationship (a brother/sister relationship) and an indirect family relationship (an uncle/nephew relationship), respectively. Relationship 305 is an example of a peer relationship, and relationship 310 is an example of a positional relationship.

FIGS. 4A-4B show the relationship deducer of FIG. 1B deducing additional relationships between tags of the tag database of FIG. 1A. In FIGS. 4A-4B, relationship deducer 180 is shown as taking several facts (i.e., tags in the tag database and relationships in the relationship database) and deducing from them additional relationships. Specifically, in FIG. 4A, relationship deducer 180 is shown as taking as input John Public tag 130, David Public tag 140, Robert Public tag 405, and relationships 410 and 415. From this information, relationship deducer 180 deduces that if David Public is the brother of Robert Public (relationship 415), and Robert Public is the father of John Public (relationship 410), then David Public is the uncle of John Public (relationship 150).

In FIG. 4B, relationship deducer 180 takes as input John Public tag 130, Sally Public tag 135, Robert Public 405, and relationships 145 and 410. From this information, relationship deducer 180 deduces that if Robert Public is the father of John Public (relationship 410), and John Public is the brother of Sally Public (relationship 145), then Robert Public is the father of Sally Public (relationship 420). (Robert Public must be the father of Sally Public: if Robert Public were not the father of Sally Public, then John Public and Sally Public would have a step-sibling relationship, rather than being brother and sister.)

It is interesting to note that in FIGS. 4A-4B, all the relationships used as inputs to relationship deducer 180 are direct family relationships. In FIG. 4B, deduced relationship 420 is a direct family relationship. In contrast, in FIG. 4A, deduced relationship 150 is an indirect family relationship. This shows that when relationship deducer 180 takes direct family relationships as input, relationship deducer 180 can sometimes produce a direct family relationship and sometimes an indirect family relationship.

Relationship deducer 180 can also take as input in direct family relationships. But because indirect family relationships imply that there is some third-party necessary to the complete understanding of the relationship between the other two parties, when relationship deducer 180 uses indirect family relationships, the best that can result is another indirect family relationship. For example, given that John Public is a brother of Sally Public (relationship 145) and that David Public is an uncle of John Public (relationship 150), the only available conclusion is that David Public is an uncle of Sally Public. But the uncle/niece relationship is an indirect family relationship, not a direct family relationship.

As an example of a situation where relationship deducer 180 cannot even conclude anything at all, consider the situation where David Public is the uncle of John Public (relationship 150), and the David Public is the brother of Robert Public (relationship 415). Given these facts, it is not possible for relationship deducer 180 to deduce any particular relationship between John Public and Robert Public. Robert Public might be the father of John Public (as in the family hierarchy under discussion). But if David Public and Robert Public have another sibling who happens to be the parent of John Public, then Robert Public is another uncle of John Public. The most that relationship deducer 180 can conclude is that there is some relationship between Robert Public and John Public, but this relationship cannot be narrowed down any further.

Relationship deducer 180 generally does not operate on positional relationships and peer relationships, as it is much more difficult to correctly deduce anything in such relationships. For example, given that John Public is a brother of Sally Public, and that John Public owns a dog named Snoopy, no relationship can be deduced between Sally Public and Snoopy (if John Public and Sally Public are both still children, then it is possible that Snoopy might be a pet also owned by Sally Public; if John Public is no longer a child, then there may be no relationship at all between Sally Public and Snoopy). On the other hand, if John Public is a husband of Susan Public, then it may be possible for relationship deducer 180 to deduce that Susan Public is an owner of Snoopy as well.

Similarly, knowing that Sally Public is a friend of chain Doe and that Jane Doe as a relationship (of any sort) with Jack Doe does not allow one to conclude that there is any kind of relationship between Sally Public and Jack Doe. Sally Public might be friends with (or even dating) Jack Doe; or Sally Public might never have met Jack Doe.

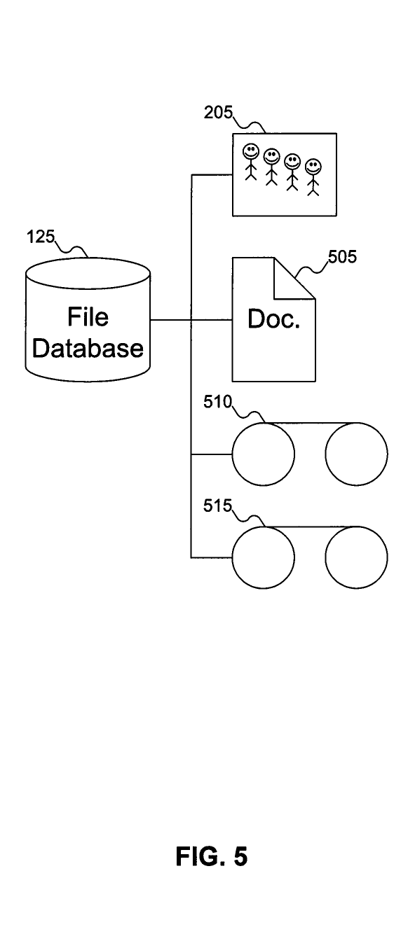

FIG. 5 shows various types of files that can be stored in the file database of FIG. 1A. In FIG. 5, file database 125 is shown as including image file 205. Image file 205 can be any type of image file: for example, a JPEG, a GIF, or bitmap, among other possibilities. File database 125 also is shown as including document 505. Document 505 can be any type of document, such as a text document, spreadsheet, or a PDF, among other possibilities. Essentially, document 505 can be any document that is capable of being tagged in an embodiment of the invention. For example, document 505 could be a birth certificate or a death certificate.

File database 125 also is shown as including multimedia file 510 and audio file 515. Multimedia file 510 can be any type of multimedia file, including data of any desired types. For example, multimedia file 510 can combine audio and video to some effect: for example, a video captured by a video camera, or a slideshow. Audio file 515 can be an audio recording of some sort: for example, an MP3 file. A person skilled in the art will recognize other types of files that can be stored in file database 125 not covered by any of the above descriptions: for example, a file that includes only video information, or a file that combines text and graphics (and potentially other information), such as a portable document format (PDF).

In FIG. 5, file database 125 is shown as including four files, a person skilled in the art will recognize that file database 125 can include any number of files. In addition, while FIG. 5 shows file database 125 as including four different types of files, a person skilled in the art will recognize that file database 125 can include any desired file types, not limited to those shown in FIG. 5.

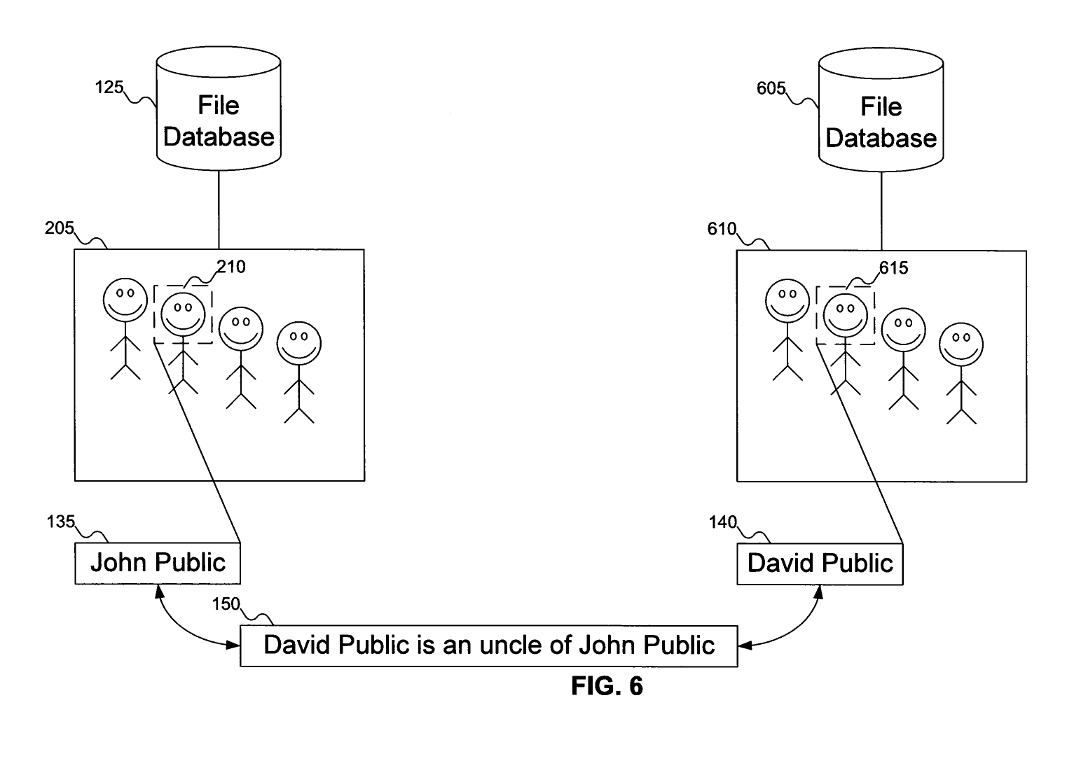

While the above discussion suggests that file database 125, tag database 110, and relationship database 115 are all stored on a single machine (machine 105 of FIG. 1A), a person skilled in the art will recognize that no such limitation is imposed on embodiments of the system. Specifically, it is possible for the various features of embodiments of the invention to reside on different machines. FIG. 6 shows a specific example of how this can occur.

In FIG. 6, the relationship database of FIG. 1A stores a relationship between files in different file databases. Specifically, in FIG. 6, file database 125 includes image file 205, which in turn includes John Public tag 130 (specifically associated with subset 210 of image file 205). File database 605, a separate database from file database 125, includes image file 610, which in turn includes David Public tag 140 (specifically associated with subset 615 of image file 610). Relationship 150 establishes that David Public is an uncle of John Public. Relationship 150 can be stored in relationship database 115 on machine 105, even though it relates to a tag that is associated with an image file stored in a separate file database. It is even possible that David Public tag 140 might not be associated with any files in file database 125, and might not even be stored in tag database 110. This shows that relationships and relationship database 115 can relate tags associated with files stored in different file databases. An embodiment of the invention in which this situation could prove useful is where the relationship database stores relationships spanning different file databases: for example, where one user manages one set of files using Facebook.com and another user manages a second set of files using MySpace.com. While Facebook.com and MySpace.com manage their files separately, a single relationship database can bridge tags associated with the files in the separate databases. This relationship database could even reside on machine separate from those managing both the Facebook.com and MySpace.com profiles.

FIG. 7A shows the set of direct family relationships in the relationship database of FIG. 1A centered on a particular tag in the tag database of FIG. 1A. In FIG. 7A, display 705 of direct family relationships is centered on John Public tag 130; a person skilled in the art will recognize that display 705 can be centered on any tag. According to display 705, the John Public tag 130 is a sibling of Sally Public 135; both John Public and Sally Public are children of Robert Public tag 405 and Jane Public 710. John Public tag 130 is married to Susan Public tag 715; their children include Sarah Public 720 and J. Public 725.

Although display 705 shows the tags represented textually, a person skilled in the art will recognize that embodiments of the invention support representing the various tags in any desired manner. For example, as discussed above with reference to FIGS. 1B-2, tags can be associated with subsets of files in the file database, called portraits. Instead of identifying the tag textually, the tag can be identified by one or more of these portraits, or subsets, of the files in the file database. For example, John Public tag 130 could be replaced with the image of subset 210 of FIG. 2. A person skilled in the art will recognize how tags can be replaced with subsets of other file types, such as video files or audio files.

As indicated by selection 730, the user has moved the mouse over Sally Public tag 135 and clicked on Sally Public tag 135. By selecting Sally Public tag 135, the user can be requesting to change the tag that is represented at the center of display 705. FIG. 7B shows the result of this change of the center point in display 705. In FIG. 2, the center of display 705 is now Sally Public tag 135. Because parents and siblings represent direct family relationships, John Public tag 130, Robert Public tag 405, and Jane Public tag 710 are still shown in display 705 of FIG. 7B; the other tags that were shown in FIG. 7A, as they are not direct family relationships to Sally Public tag 135, are not shown. In addition, as no other tags are shown in FIG. 7B, it can be concluded that Sally Public is not married and has no children.

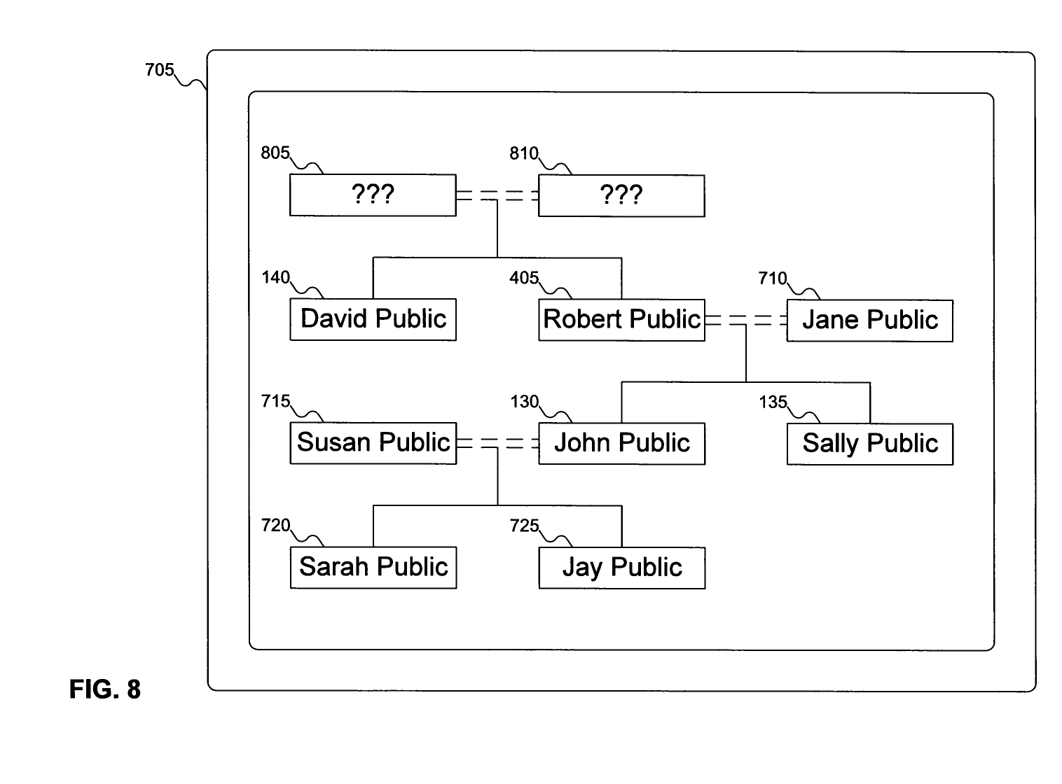

While FIGS. 7A-7B show display 705 including only the direct family relationships of the tag at the center of display 705, a person skilled in the art will recognize that display 705 can also show indirect relationships. FIG. 8 shows John Public tag 130 at the center of display 705, but also including indirect relationships for John Public tag 130. For example, in FIG. 8, the indirect relationship of John Public tag 130 with his uncle David Public tag 140 is shown. Presumably, as David Public tag 140 is the brother of Robert Public tag 405, David Public tag 140 and Robert Public tag 405 have parents; these parents are represented as tags 805 and 810. For whatever reason, at the time display 705 was generated in FIG. 8, the identities of the paternal grandparents of John Public tag 130 were not known; this fact explains why he tags 805 and 810 are marked with question marks instead of names. A person skilled in the art will also recognize that tags 805 and 810 might not have been added just to explain the direct family relationship between David Public tag 140 and Robert Public tag 405. For example, tags 805 and 810 could have been created prior to the creation of David Public tag 140, as these people were known to exist (even if their identities were not known).

While FIG. 8 only shows family relationships (direct and indirect), a person skilled in the art will recognize that embodiments of the invention are not limited to showing only family relationships in display 705. For example, in one embodiment of the invention, display 705 can show the positional relationships and peer relationships including John Public tag 130. In another embodiment of the invention, display 705 can show the family relationships, and provide the user with a toggle (not shown in FIG. 8) that enables the user to select which types of relationships the user wants represented on display 705. In this manner, the user would be able to request, say, just the positional relationships for John Public tag 130, or the family relationships and peer relationships for John Public tag 130. (As embodiments of the invention includes four different types of relationships—direct family relationships, indirect family relationships, positional relationships, and peer relationships—display 705 can include a toggle for each type of relationship, giving the user complete control over what relationships to present on display 705.

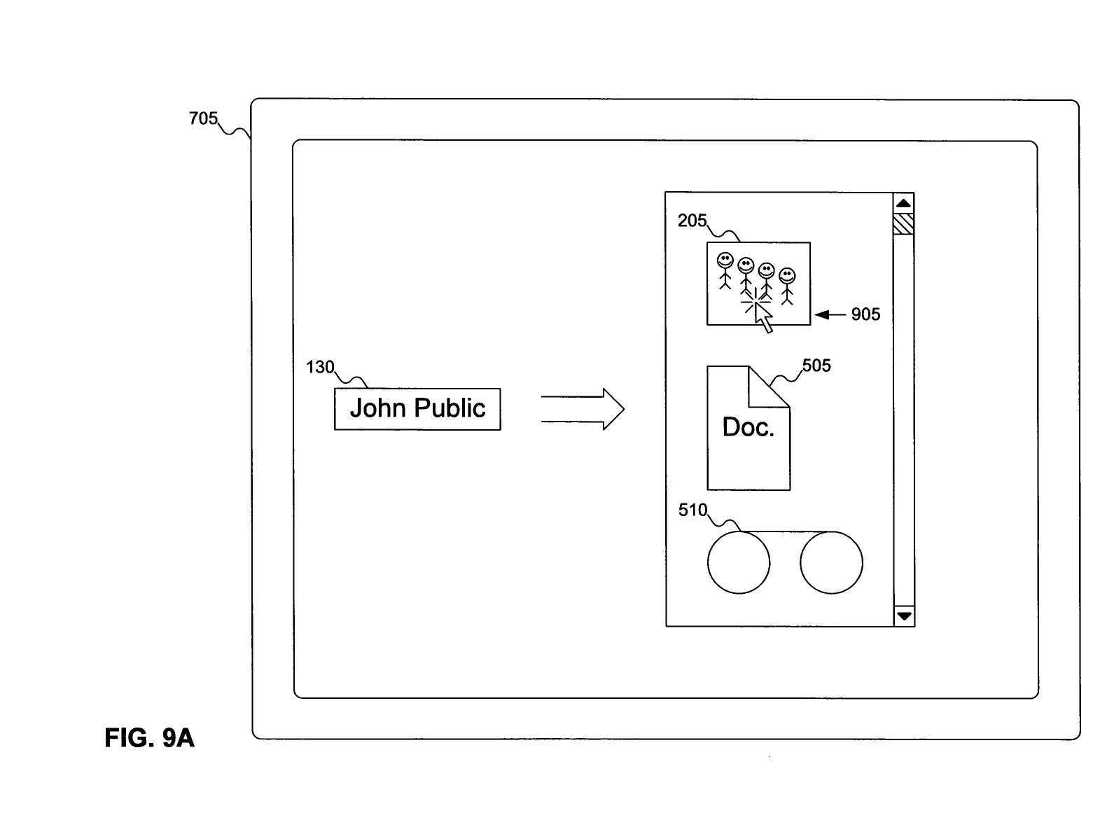

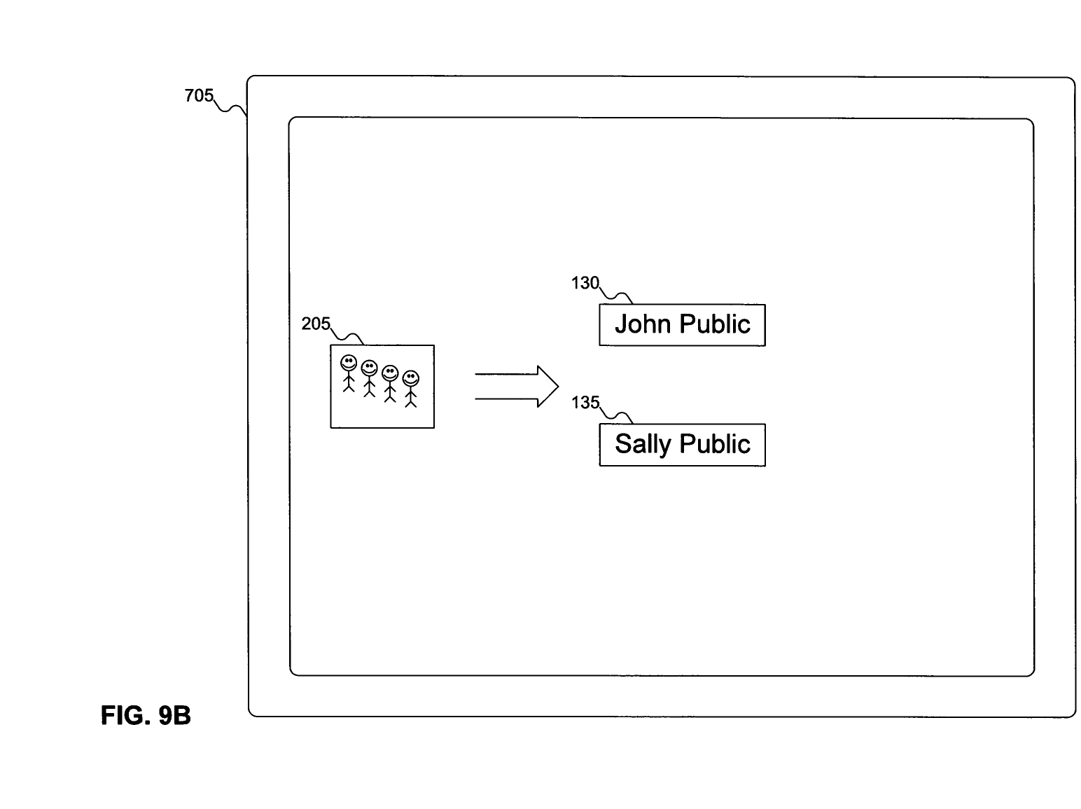

FIG. 9A shows a set of files in the file database of FIG. 1A associated with a particular tag in the tag database of FIG. 1A. In contrast to FIGS. 7A-8, FIG. 9A enables the user to identify which files in the file database are associated with a particular tag. Thus, as the user is currently focused on John Public tag 130, display 705 shows to the user which files are currently associated with this tag: among others, image file 205, document 505, and multimedia file 510.

In an embodiment of the invention, the system not only identifies to the user which files are associated with a particular tag, but the user can also select one of these files and identify all the tags associated with that particular file. For example, as indicated by selection 905, the user has moved the mouse over image file 205 and selected it. The result of this election is shown in FIG. 9B. In FIG. 9B, the focus is now on image file 205. Associated with image file 205 are two tags: John Public tag 130 and Sally Public tag 135. Embodiments of the invention also enable the user to reverse the process: for example, if the user were to then click on Sally Public tag 130, the system would then displayed to the user all files in the file database associated with a Sally Public tag 130.

The embodiments of the invention represented in FIGS. 7A-9B are not mutually exclusive. That is, at any point the selection of the tag could either change the centering of display 705 on the selected tag or present the files associated with that tag. A person skilled in the art will recognize different ways in which this can be accomplished. For example, the selection of a tag does not have to automatically result in a change of display 705; it might merely result in the system recognizing the tag of interest to the user. At this point, the user could then make a separate selection indicating whether the user is interested in re-centering the display or seeing the files associated with that tag.

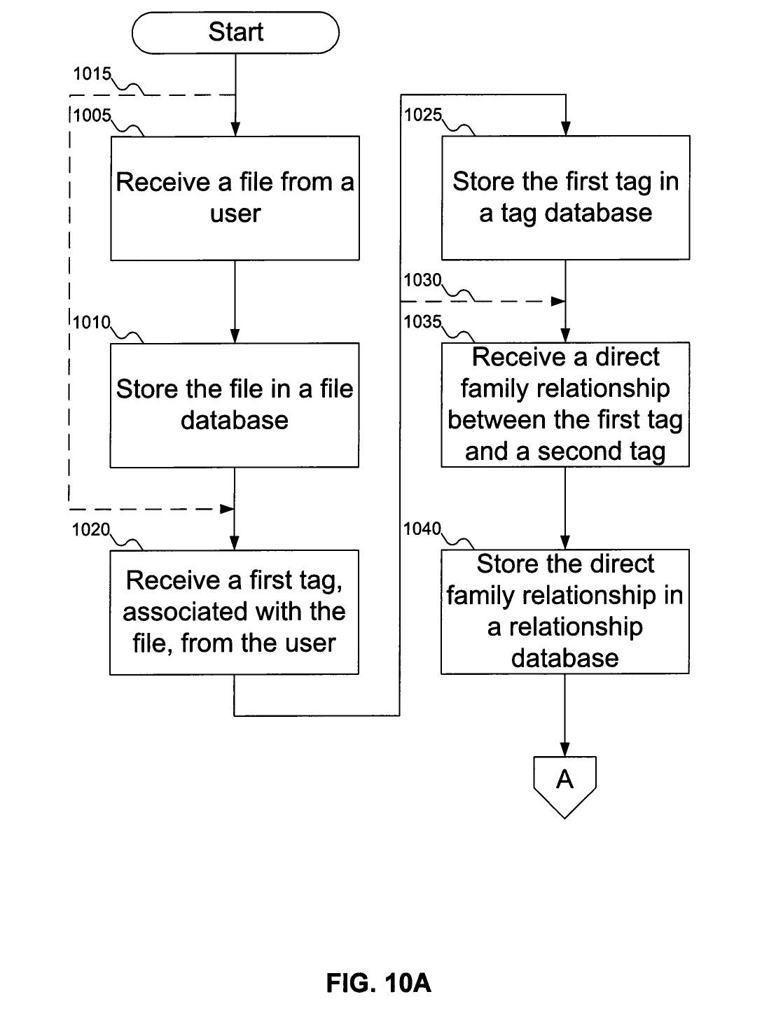

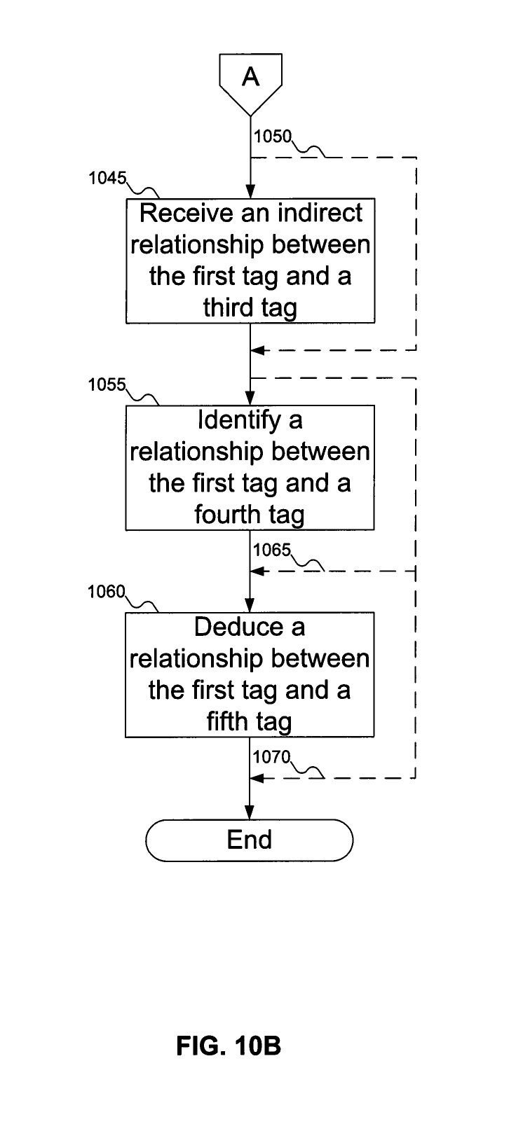

FIGS. 10A-10B show a flowchart of a procedure to establish a direct family relationship in the relationship database of FIG. 1A between tags in the tag database of FIG. 1A. In FIG. 10A, at block 1005, the system receives a file from the user. At block 1010, the system stores the file in a file database. Blocks 1005 and 1010 are optional, as shown by dashed line 1015. At block 1020, the system receives the first tag from the user; this tag is to be associated with a subset of the file at block 1025, the system stores the first tag in a tag database. Block 1025 is optional, as shown by dashed line 1030. At block 1035, the system receives from the user a direct family relationship between the first tag and a second tag. Finally, at block 1040, the system stores the direct family relationship received from the user in a relationship database.

FIG. 10B shows some optional steps that can also be performed in embodiments of the invention. At block 1045, the system receives from the user and indirect relationship (and indirect family relationship, positional relationship, or a peer relationship) between the first tag and a third tag in the tag database. Block 1045 is optional, as shown by dashed line 1050. At block 1055, the system can identify relationship that exists between the first tag and a fourth tag, and at block 1060, the system can use this information to deduce relationship between the first tag and yet another tag. Blocks 1055 and 1060 are optional: block 1055 can be omitted as shown by dashed line 1065, and both blocks 1055 and 1055 can be omitted as shown by dashed line 1070.

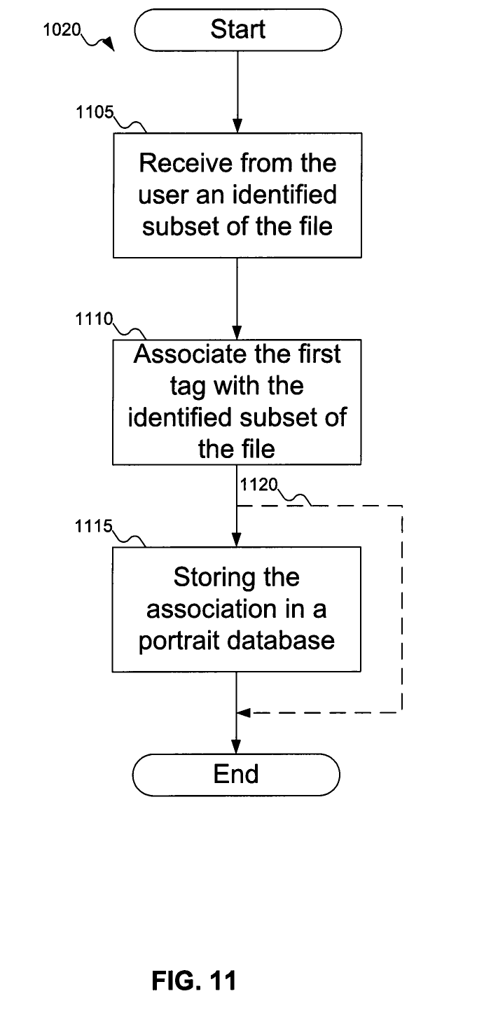

As discussed above with reference to FIG. 2, tags can be associated, not with the file as a whole, but with a subset of the file. FIG. 11 shows a flowchart of a procedure to associate a tag in the tag database of FIG. 1A with a subset of a file in the file database of FIG. 1A. In FIG. 11, at block 1105, the system receives from the user unidentified subset of the file. At block 1110, the system associates the first tag with the identified subset of the file. At block 1115, the system stores the association between the first tag and the identified subset of the file (a portrait) in a portrait database. Block 1115 is optional, as shown by dashed line 1120.

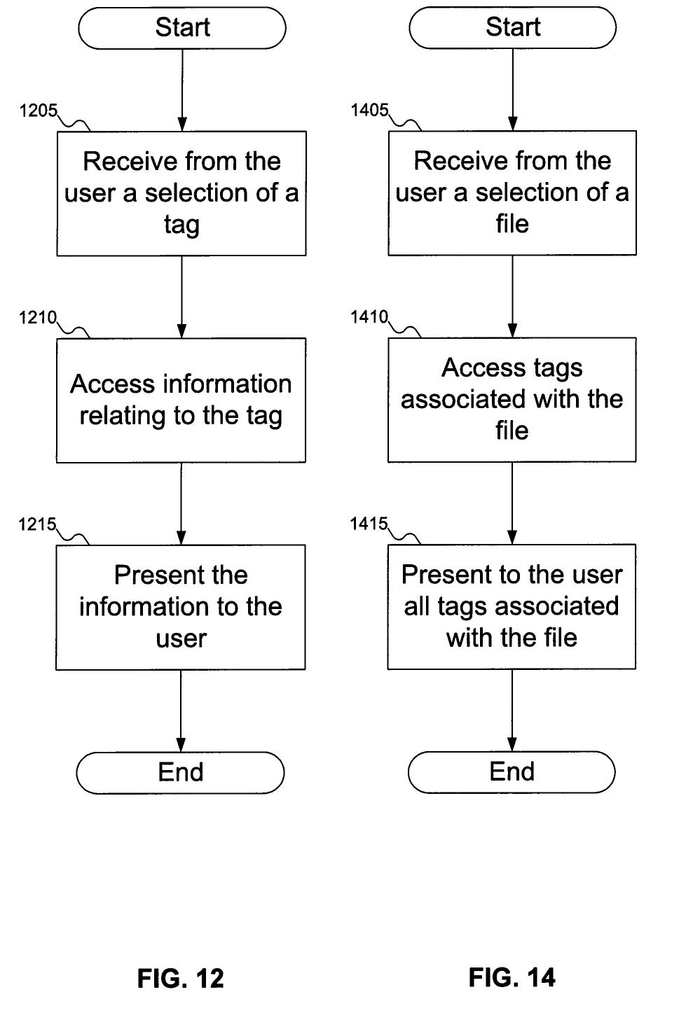

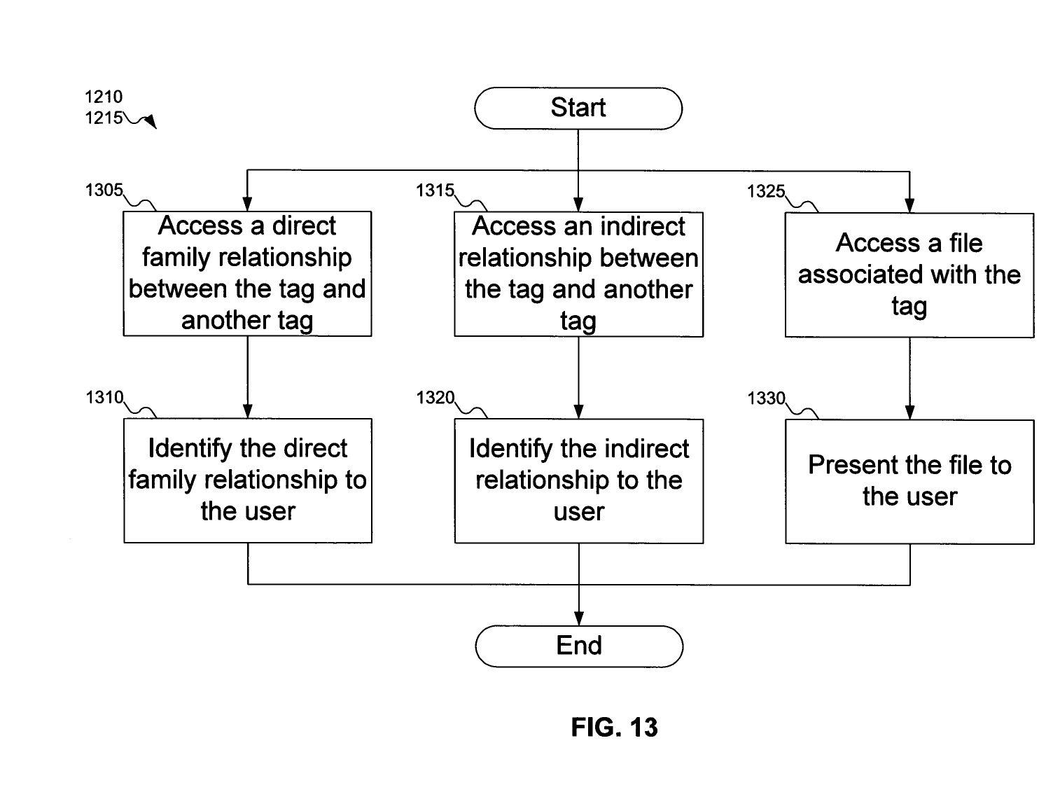

FIGS. 12-13 show a flowchart of a procedure to present to a user information relating to a tag in the tag database of FIG. 1A. In FIG. 12, at block 1205, the system receives from the user a selection of attack. At block 1210, the system accesses information relating to that tag, and at block 1215, the system presents this information to the user.

In FIG. 13, at block 1305, the system accesses a direct family relationship between the tag and another tag, and at block 1310 the system identifies this direct family relationship to the user. Alternatively, at block 1315, the system accesses an indirect relationship between the tag and another tag, and at block 1320 the system identifies this indirect relationship to the user. Alternatively, at block 1325, the system accesses a file associated with the tag, and at block 1330 the system presents the file to the user.

FIG. 14 shows a flowchart of a procedure to present to a user information relating to a file in the file database of FIG. 1A. In FIG. 14, at block 1405, the system receives from the user's selection of the file. At block 1410, the system accesses tags associated with that file, and at block 1415 the system presents to the user all tags associated with that file.

The following discussion is intended to provide a brief, general description of a suitable machine in which certain aspects of the invention can be implemented. Typically, the machine includes a system bus to which is attached processors, memory, e.g., random access memory (RAM), read-only memory (ROM), or other state preserving medium, storage devices, a video interface (185), and input/output interface (185) ports. The machine can be controlled, at least in part, by input from conventional input devices, such as keyboards, mice, etc., as well as by directives received from another machine, interaction with a virtual reality (VR) environment, biometric feedback, or other input signal. As used herein, the term “machine” is intended to broadly encompass a single machine, or a system of communicatively coupled machines or devices operating together. Exemplary machines include computing devices such as personal computers, workstations, servers, portable computers, handheld devices, telephones, tablets, etc., as well as transportation devices, such as private or public transportation, e.g., automobiles, trains, cabs, etc.

The machine can include embedded controllers, such as programmable or non-programmable logic devices or arrays, Application Specific Integrated Circuits, embedded computers, smart cards, and the like. The machine can utilize one or more connections to one or more remote machines, such as through a network interface (185), modem, or other communicative coupling. Machines can be interconnected by way of a physical and/or logical network, such as an intranet, the Internet, local area networks, wide area networks, etc. One skilled in the art will appreciate that network communication can utilize various wired and/or wireless short range or long range carriers and protocols, including radio frequency (RF), satellite, microwave, Institute of Electrical and Electronics Engineers (IEEE) 545.11, Bluetooth, optical, infrared, cable, laser, etc.

The invention can be described by reference to or in conjunction with associated data including functions, procedures, data structures, application programs, instructions, etc. which, when accessed by a machine, result in the machine performing tasks or defining abstract data types or low-level hardware contexts. Associated data can be stored in, for example, the volatile and/or non-volatile memory, e.g., RAM, ROM, etc., or in other storage devices and their associated storage media, including hard-drives, floppy-disks, optical storage, tapes, flash memory, memory sticks, digital video disks, biological storage, and other tangible, physical storage media. Associated data can also be delivered over transmission environments, including the physical and/or logical network, in the form of packets, serial data, parallel data, propagated signals, etc., and can be used in a compressed or encrypted format. Associated data can be used in a distributed environment, and stored locally and/or remotely for machine access.

Having described and illustrated the principles of the invention with reference to illustrated embodiments, it will be recognized that the illustrated embodiments can be modified in arrangement and detail without departing from such principles, and can be combined in any desired manner. And although the foregoing discussion has focused on particular embodiments, other configurations are contemplated. In particular, even though expressions such as “according to an embodiment of the invention” or the like are used herein, these phrases are meant to generally reference embodiment possibilities, and are not intended to limit the invention to particular embodiment configurations. As used herein, these terms can reference the same or different embodiments that are combinable into other embodiments.

Consequently, in view of the wide variety of permutations to the embodiments described herein, this detailed description and accompanying material is intended to be illustrative only, and should not be taken as limiting the scope of the invention. What is claimed as the invention, therefore, is all such modifications as can come within the scope and spirit of the following claims and equivalents thereto.

1. An apparatus, comprising:
a file database (125) to store at least one file (120, 205, 505, 510, 515);
a tag database (110) to store at least a first tag (130, 135, 140, 405, 710, 715, 720, 725) associated with said one file (120, 205, 505, 510, 515); and
a relationship database (115) to store at least one direct family relationship (145, 410, 415, 420) between said first tag (130, 135, 140, 405, 710, 715, 720, 725) and a second tag (130, 135, 140, 405, 710, 715, 720, 725) in the tag database (110).

2. An apparatus according to claim 1, wherein the relationship database (115) is operative to store at least one indirect relationship (150, 305, 310) between said first tag (130, 135, 140, 405, 710, 715, 720, 725) and a third tag (130, 135, 140, 405, 710, 715, 720, 725).

3. An apparatus according to claim 2, wherein said indirect relationship (150, 305, 310) is drawn from a set including an indirect family relationship (150), a positional relationship (310), and a peer relationship (305).

4. An apparatus according to claim 1, further comprising a relationship deducer (180) to deduce a relationship (145, 150, 305, 310, 410, 415) between said first tag (130, 135, 140, 405, 710, 715, 720, 725) and a third tag (130, 135, 140, 405, 710, 715, 720, 725) in the tag database (110).

5. An apparatus according to claim 4, wherein the relationship deducer (180) is operative to deduce the relationship (145, 150, 305, 310, 410, 415) between said first tag (130, 135, 140, 405, 710, 715, 720, 725) and said third tag (130, 135, 140, 405, 710, 715, 720, 725) using a relationship (145, 150, 305, 310, 410, 415) between said second tag (130, 135, 140, 405, 710, 715, 720, 725) and said third tag (130, 135, 140, 405, 710, 715, 720, 725).

6. An apparatus according to claim 1, wherein the file (120, 205, 505, 510, 515) is drawn from a set including a multimedia file (510), an image file (205, 610), an audio file (515), and a document (505).

7. An apparatus according to claim 1, wherein said first tag (130, 135, 140, 405, 710, 715, 720, 725) is associated (160) with a subset (210, 215, 615) of said one file (120, 205, 505, 510, 515).

8. An apparatus according to claim 7, further comprising a portrait database (155) to store a portrait (160) associating said first tag (130, 135, 140, 405, 710, 715, 720, 725) with said subset (210, 215, 615) of said one file (120, 205, 505, 510, 515).

9. An apparatus according to claim 1, wherein said second tag (130, 135, 140, 405, 710, 715, 720, 725) is associated with a second file (120, 205, 505, 510, 515).

10. An apparatus according to claim 9, wherein the file database (125) is operative to store said second file (120, 205, 505, 510, 515).

11. An apparatus according to claim 9, wherein said second file (120, 205, 505, 510, 515) is stored in a second file database (605) separate from the file database (125).

12. An apparatus according to claim 1, further comprising an interface (185) to present to a user said first tag (130, 135, 140, 405, 710, 715, 720, 725) and all direct family relationships (145, 410, 415, 420) including said first tag (130, 135, 140, 405, 710, 715, 720, 725).

13. An apparatus according to claim 12, wherein the interface (185) is operative to receive from said user a selection (730) of said second tag (130, 135, 140, 405, 710, 715, 720, 725) and present to said user said second tag (130, 135, 140, 405, 710, 715, 720, 725) and all direct family relationships (145, 410, 415, 420) including said second tag (130, 135, 140, 405, 710, 715, 720, 725).

14. An apparatus according to claim 12, wherein the interface (185) is further operative to present to said user all indirect relationships (150, 305, 310) including said first tag (130, 135, 140, 405, 710, 715, 720, 725).

15. An apparatus according to claim 1, further comprising an interface (185) to present to a user said first tag (130, 135, 140, 405, 710, 715, 720, 725) and all files (120, 205, 505, 510, 515) including said first tag (130, 135, 140, 405, 710, 715, 720, 725).

16. An apparatus according to claim 15, wherein the interface (185) is further operative to receive from said user a selection (905) of said one file (120, 205, 505, 510, 515) and to present to said user all tags (130, 135, 140, 405, 710, 715, 720, 725) associated with said file (120, 205, 505, 510, 515).

17. An apparatus according to claim 16, wherein the interface (185) is further operative to receive from said user a selection (730) of said second tag (130, 135, 140, 405, 710, 715, 720, 725) and to present to said user all files (120, 205, 505, 510, 515) associated with said second tag (130, 135, 140, 405, 710, 715, 720, 725).

18. A computer-implemented method, comprising:
receiving (1020) a first tag (130, 135, 140, 405, 710, 715, 720, 725) from a user, the first tag (130, 135, 140, 405, 710, 715, 720, 725) associated with a file (120, 205, 505, 510, 515);
receiving (1035) a direct family relationship (145, 410, 415, 420) from the user, the direct family relationship (145, 410, 415, 420) between the first tag (130, 135, 140, 405, 710, 715, 720, 725) and a second tag (130, 135, 140, 405, 710, 715, 720, 725); and
storing (1040) the direct family relationship (145, 410, 415, 420) in a relationship database (115).

19. A method according to claim 18, further comprising receiving (1005) the file (120, 205, 505, 510, 515) from the user.

20. A method according to claim 19, further comprising storing (1010) the file (120, 205, 505, 510, 515) in a file database (125).

21. A method according to claim 18, further comprising storing (1025) the first tag (130, 135, 140, 405, 710, 715, 720, 725) in a tag database (110).

22. A method according to claim 18, wherein receiving (1020) a first tag (130, 135, 140, 405, 710, 715, 720, 725) from a user includes:
receiving (1105) from the user an identified subset (210, 215, 615) of the file (120, 205, 505, 510, 515); and
associating (1110) the first tag (130, 135, 140, 405, 710, 715, 720, 725) with the identified subset (210, 215, 615) of the file (120, 205, 505, 510, 515).

23. A method according to claim 22, wherein associating (1110) the first tag (130, 135, 140, 405, 710, 715, 720, 725) with the identified subset (210, 215, 615) of the file (120, 205, 505, 510, 515) includes storing (1115) an association (160) between the first tag (130, 135, 140, 405, 710, 715, 720, 725) and the identified subset (210, 215, 615) of the file (120, 205, 505, 510, 515) in a portrait database (155).

24. A method according to claim 18, wherein receiving (1020) a first tag (130, 135, 140, 405, 710, 715, 720, 725) from a user includes:
receiving (1020) the first tag (130, 135, 140, 405, 710, 715, 720, 725) from the user, the first tag (130, 135, 140, 405, 710, 715, 720, 725) associated with the file (120, 205, 505, 510, 515), the file (120, 205, 505, 510, 515) drawn from a set including a multimedia file (510), an image file (205, 610), an audio file (515), and a document (505).

25. A method according to claim 18, further comprising receiving (1045) an indirect relationship (150, 305, 310) from the user, the indirect relationship (150, 305, 310) between the first tag (130, 135, 140, 405, 710, 715, 720, 725) and a third tag (130, 135, 140, 405, 710, 715, 720, 725).

26. A method according to claim 25, wherein receiving (1045) an indirect relationship (150, 305, 310) from the user includes receiving (1045) the indirect relationship (150, 305, 310) from the user, the indirect relationship (150, 305, 310) drawn from a set including an indirect family relationship (150), a positional relationship (310), and a peer relationship (305).

27. A method according to claim 18, further comprising deducing (1060) a relationship (145, 150, 305, 310, 410, 415) between the first tag (130, 135, 140, 405, 710, 715, 720, 725) and a third tag (130, 135, 140, 405, 710, 715, 720, 725).

28. A method according to claim 27, wherein deducing (1060) a relationship (145, 150, 305, 310, 410, 415) between the first tag (130, 135, 140, 405, 710, 715, 720, 725) and a third tag (130, 135, 140, 405, 710, 715, 720, 725) includes identifying (1055) a relationship (145, 150, 305, 310, 410, 415) between the second tag (130, 135, 140, 405, 710, 715, 720, 725) and the third tag (130, 135, 140, 405, 710, 715, 720, 725).

29. A method according to claim 18, wherein receiving (1035) a direct family relationship (145, 410, 415, 420) from the user includes receiving (1035) the direct family relationship (145, 410, 415, 420) from the user, the direct family relationship (145, 410, 415, 420) between the first tag (130, 135, 140, 405, 710, 715, 720, 725) and the second tag (130, 135, 140, 405, 710, 715, 720, 725), the second tag (130, 135, 140, 405, 710, 715, 720, 725) associated with a second file (120, 205, 505, 510, 515).

30. A method according to claim 29, wherein receiving (1035) the direct family relationship (145, 410, 415, 420) from the user includes receiving (1035) the direct family relationship (145, 410, 415, 420) from the user, the direct family relationship (145, 410, 415, 420) between the first tag (130, 135, 140, 405, 710, 715, 720, 725) and the second tag (130, 135, 140, 405, 710, 715, 720, 725), the second tag (130, 135, 140, 405, 710, 715, 720, 725) associated with the second file (120, 205, 505, 510, 515), the second file (120, 205, 505, 510, 515) stored in a second file database (605) not storing the file (120, 205, 505, 510, 515).

31. A method according to claim 18, further comprising:
receiving (1205) a request from the user to select the second tag (130, 135, 140, 405, 710, 715, 720, 725);
accessing (1210) information related to the second tag (130, 135, 140, 405, 710, 715, 720, 725); and
presenting (1215) the information to the user.

32. A method according to claim 31, wherein:
accessing (1210) information related to the second tag (130, 135, 140, 405, 710, 715, 720, 725) includes accessing (1305) at least second direct family relationship (145, 410, 415, 420) between the second tag (130, 135, 140, 405, 710, 715, 720, 725) and a third tag (130, 135, 140, 405, 710, 715, 720, 725); and
presenting (1215) the information to the user includes identifying (1310) to the user the third tag (130, 135, 140, 405, 710, 715, 720, 725) and the second direct family relationship (145, 410, 415, 420).

33. A method according to claim 31, wherein:
accessing (1210) information related to the second tag (130, 135, 140, 405, 710, 715, 720, 725) further includes accessing (1315) at least a first indirect relationship (150, 305, 310) between the second tag (130, 135, 140, 405, 710, 715, 720, 725) and a fourth tag (130, 135, 140, 405, 710, 715, 720, 725); and
presenting (1215) the information to the user further includes identifying (1320) to the user the fourth tag (130, 135, 140, 405, 710, 715, 720, 725) and the indirect relationship (150, 305, 310).

34. A method according to claim 31, wherein:
accessing (1210) information related to the second tag (130, 135, 140, 405, 710, 715, 720, 725) includes accessing (1325) at least a second file (120, 205, 505, 510, 515) associated with the second tag (130, 135, 140, 405, 710, 715, 720, 725); and
presenting (1215) the information to the user includes presenting (1330) the second file (120, 205, 505, 510, 515) to the user.

35. A method according to claim 34, wherein accessing (1325) at least a second file (120, 205, 505, 510, 515) associated with the second tag (130, 135, 140, 405, 710, 715, 720, 725) includes accessing (1325) at least the second file (120, 205, 505, 510, 515) associated with the second tag (130, 135, 140, 405, 710, 715, 720, 725), the second file (120, 205, 505, 510, 515) stored in a second file database (605) not storing the file (120, 205, 505, 510, 515).

36. A method according to claim 18, further comprising:
receiving (1405) a request from the user to select a second file (120, 205, 505, 510, 515);
accessing (1410) all tags (130, 135, 140, 405, 710, 715, 720, 725) associated with the second file (120, 205, 505, 510, 515); and
presenting (1415) the tags (130, 135, 140, 405, 710, 715, 720, 725) associated with the second file (120, 205, 505, 510, 515) to the user.
